(19) United States
(12) Patent Application Publication
(10) Pub. No.: US 2023/0243686 A1
(43) Pub. Date: Aug. 3, 2023

(54) FILL LEVEL RADAR FOR FILL LEVEL AND TOPOLOGY CAPTURING

(71) Applicant: VEGA GRIESHABER KG, Wolfach (DE)

(72) Inventors: Roland WELLE, Hausach (DE); Steffen WAELDE, Niedereschach (DE)

(73) Assignee: VEGA GRIESHABER KG, Wolfach (DE)

(21) Appl. No.: 18/001,670

(22) PCT Filed: Jun. 18, 2020
(86) PCT No.: PCT/EP2020/066937

§ 371 Date: Dec. 13, 2022

(51) Int. Cl. G01F 23/284; G01S 13/89; G01S 7/03

(52) U.S. Cl. CPC G01F 23/284; G01S 13/89; G01S 7/03

(57) ABSTRACT

A fill level radar for fill level and topology detection is provided, including: a fill level radar device configured to detect a fill level of a container; a topology radar device configured to detect the topology of a product surface; an energy management device configured to monitor available energy; and control circuitry configured to adjust a timing of measurements of the fill level radar unit and the topology radar unit taking into account available energy. A method for measuring a fill level of a container and a topology of a product surface, and a nontransitory computer-readable storage medium including computer program instructions stored therein, which when executed on a processor of a level meter, instructs the level meter to perform the method, are also provided.

### FIELD OF THE INVENTION

The invention relates to the measurement of product surfaces. In particular, the invention relates to a fill level radar for level and topology detection, a method for measuring a fill level of a container and a topology of a product surface, a program element and a computer-readable medium.

### TECHNICAL BACKGROUND

To detect the topology of a product surface, the product surface can be scanned with a measurement signal. Either the measuring device or its antenna is mechanically swiveled for this purpose, or electronic beam control is used. It is also possible to mix the two. For electronic beam steering, an array of radiator elements is used in radar measuring devices. In this context, one also speaks of an array antenna.

The detected topology can then be used to calculate the fill level and the volume of the product.

The hardware effort for the electronic beam control cannot be neglected; the computing effort required for signal evaluation can also be considerable. For this reason, such measuring devices require a relatively large amount of energy.

However, energy is often a scarce commodity, depending on the location and connection of the measuring device.

### SUMMARY OF THE PRESENT INVENTION

Against this background, it is a task of the present invention to specify a fill level radar for fill level and topology detection, which provides reliable measurement results even with limited available energy.

This task is solved by the features of the independent patent claims. Further embodiments of the invention result from the dependent claims and the following description of embodiments.

A first aspect of the present disclosure relates to a fill level radar for level and topology detection, and in particular for process automation in an industrial environment. The fill level radar comprises a fill level radar unit or an ultrasonic unit configured to detect a fill level of a container. It also has a topology radar unit configured to detect the topology of a product surface of a product in the container. An energy management unit is provided, which is configured to monitor the available energy that can be used for measurement. A control circuitry is provided which is configured to configure the timing of the measurements of the fill level radar unit and the measurements of the topology radar unit, taking into account the available energy.

For example, it can be provided that the time sequence of the measurements of the fill level radar unit and the topology radar unit is carried out taking into account the last measured fill level and/or taking into account a last measured rate of change of the fill level.

If the fill level is low, for example, more topology measurements can be performed or a topology measurement can be triggered which would otherwise not take place at this time. Also, if the fill level is changing rapidly, the frequency of the topology measurement can be reduced to realize fast tracking of the changing fill level value.

The energy management unit can have an energy storage and be configured to charge the energy storage during several successive measurements of the fill level radar unit.

Here, it helps if the fill level radar unit is designed in such a way that it requires less energy for its measurement than the topology radar unit.

In particular, the fill level radar can be configured for connection to a 4 to 20 mA interface.

According to one embodiment of the present disclosure, the fill level radar is configured for so-called “inverse operation”. “Inverse operation” in this context means that, in contrast to the “normal” configuration, a current consumption of 20 mA occurs when the container is empty (and not of 4 mA) and a current consumption of 4 mA occurs when the container is full (and not of 20 mA).

In this way, it is possible to collect sufficient energy during level measurements when the container is empty, in order to be able to carry out a topology measurement as quickly as possible.

According to a further embodiment, the control circuitry comprises a first control unit for controlling the fill level radar unit and a second control unit for controlling the topology radar unit. Furthermore, a higher-level third control unit is provided for setting the time sequence of the measurements of the fill level radar unit and the topology radar unit, taking into account the available energy. The units for topology measurement and for level measurement can be designed as autonomously operating units, which only receive the signal “Measure now” from the third control unit via a control line. This can take the form of a change of state from “0” to “1”, for example.

In particular, the fill level and topology measurement units may include first and second control units that control the complete unit respectively.

According to another embodiment, the fill level radar has a first antenna configuration configured to detect the fill level and a second antenna configuration configured to detect the topology. “Overlaps” of the two antenna configurations are generally not provided. For example, the first antenna configuration is a relatively large antenna horn, and the second antenna configuration is an array of smaller radiator elements arranged around the antenna horn, for example.

According to another embodiment, an FMCW radar signal is transmitted via the second antenna configuration, and a pulse signal is transmitted via the first antenna configuration.

The pulse signal can be, for example, a radar signal or an ultrasonic signal.

The fill level radar has an antenna system. The antenna system has, for example, a first antenna configuration configured to detect the topology of the product surface. It also has, for example, a second, additional antenna configuration configured to detect the fill level. Different antenna configurations are therefore used for level measurement and for topology detection.

The first antenna configuration is an array antenna with an array of radiator elements arranged around the second antenna configuration.

For example, the second antenna configuration is a horn antenna.

The radiator elements of the first antenna configuration can also be (smaller) horn antennas. They could also be called horn radiators, and they can be filled with a dielectric. Also, they can be in the form of waveguide openings (filled or unfilled). Patch antennas, rod radiators or other antennas can also be used.

According to one embodiment, the diameter or edge length of the radiator elements of the first antenna configuration is (significantly) smaller than the diameter or edge length of the second antenna configuration.

According to a further embodiment, the radiating surfaces of the radiator elements of the first antenna configuration and the radiating surface of the second antenna configuration are arranged on the same plane. The “radiating surface” of the second antenna configuration is, for example, the aperture of the antenna horn. The radiating surface of the radiator elements of the first antenna configuration is, in the case of horn antennas, also the plane of the opening of the individual antenna horns. In the case of planar radiator elements (patch antennas), the radiating surfaces are formed by their surface.

According to a further embodiment, the radiating surfaces of the radiator elements of the first antenna configuration and/or the radiating surface of the second antenna configuration are holes in a metallic plate. The holes may be filled or unfilled with a dielectric. The holes may have a circular or angular cross-section.

For example, the metallic plate is round.

For example, the radiator elements of the first antenna configuration form a rectangle, hexagon, or other polygonal shape with sectional straight areas.

According to one embodiment, the radiator elements of the first antenna configuration comprise a (first) group of transmitting elements and a (second) group of receiving elements. Another aspect of the present disclosure relates to a radar measuring device, in particular a fill level radar measuring device, comprising an antenna system described above and below.

For example, the fill level radar is configured to transmit an FMCW radar signal using the first antenna configuration and a pulse signal using the second antenna configuration.

Another aspect of the present disclosure relates to a method for measuring a fill level of a container and a topology of a product surface, wherein the fill level of the container is detected with a fill level radar unit of the fill level radar one or several consecutive times. The available energy is continuously monitored and a decision is made as to when the topology is to be detected, taking into account the available energy. Other conditions can be taken into account in this decision, for example the current fill level or the current rate of change of the fill level. Once it has been decided that the topology is now to be detected, the topology of the product surface is detected with a topology radar unit of the fill level radar.

Another aspect of the present disclosure relates to a program element that, when executed on the processor of a fill level meter or fill level radar, instructs the fill level meter to perform the steps described above and below.

Another aspect of the present disclosure relates to a computer-readable medium on which the program element described above is stored.

The term “process automation in the industrial environment” can be understood as a subfield of technology that includes measures for the operation of machines and plants without the involvement of humans. One goal of process automation is to automate the interaction of individual components of a plant in the chemical, food, pharmaceutical, petroleum, paper, cement, shipping or mining industries. A wide range of sensors can be used for this purpose, which are adapted in particular to the specific requirements of the process industry, such as mechanical stability, insensitivity to contamination, extreme temperatures and extreme pressures. Measured values from these sensors are usually transmitted to a control room, where process parameters such as fill level, limit level, flow rate, pressure or density can be monitored and settings for the entire plant can be changed manually or automatically.

One subfield of process automation in the industrial environment concerns logistics automation. In the field of logistics automation, distance and angle sensors are used to automate processes inside or outside a building or within a single logistics facility. Typical applications include systems for logistics automation in the area of baggage and freight handling at airports, in the area of traffic monitoring (toll systems), in retail, parcel distribution or also in the area of building security (access control). Common to the examples listed above is that presence detection in combination with precise measurement of the size and location of an object is required by the respective application side. Sensors based on optical measurement methods using lasers, LEDs, 2D cameras or 3D cameras that measure distances according to the time-of-flight (ToF) principle can be used for this purpose.

Another subfield of process automation in the industrial environment concerns factory/production automation. Use cases for this can be found in a wide variety of industries such as automotive manufacturing, food production, the pharmaceutical industry or generally in the field of packaging. The goal of factory automation is to automate the production of goods by machines, production lines and/or robots, i.e. to let it run without the involvement of humans. The sensors used in this process and the specific requirements with regard to measuring accuracy when detecting the position and size of an object are comparable to those in the previous example of logistics automation.

In the following, embodiments of the present disclosure are described with reference to the figures. If the same reference signs are used in the following description of figures, these designate the same or similar elements. The illustrations in the figures are schematic and not to scale.

### BRIEF DESCRIPTION OF THE FIGURES

FIG. 1a shows a fill level radar measuring device.

FIG. 1b shows a radar measuring device that detects the topology of a product surface.

FIG. 2a shows a radar measuring device according to an embodiment.

FIG. 2b shows the radar measuring device of FIG. 2a generating different transmission lobes.

FIG. 3 shows a fill level radar according to an embodiment.

FIG. 4 shows a flow diagram of a method according to an embodiment.

### DETAILED DESCRIPTION OF THE EMBODIMENTS

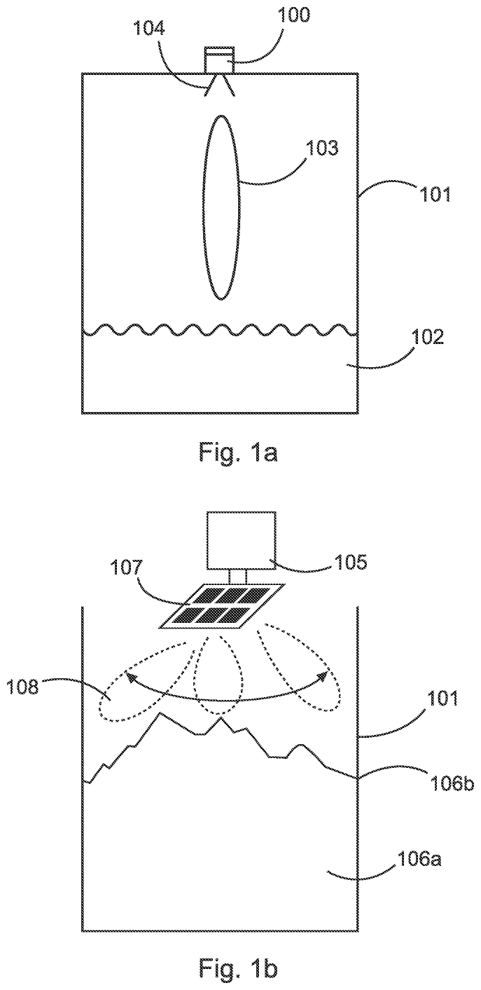

FIG. 1a shows a fill level radar 100 with a horn antenna 104 installed in a container 101. The container 101 contains the filling material 102.

A radar beam 103 is emitted via the antenna 104 in the direction of the product 102. The product can be a liquid or a bulk material. The radar signal is reflected at the product surface and then received again by the antenna 104. The distance to the product 102 can then be determined by a special evaluation circuit.

FIG. 1b shows a topology sensing level measuring device that scans the bulk material surface 106b using optical, acoustic or radar-based methods. In the following, topology sensing radar devices 105 with an electronic or digital beam sweep are considered in particular. In these devices, many radar channels are used, which can perform beam sweeping of the main beam direction 108 by different control of the transmit channels and/or different evaluation of the receive channels. Such devices have multiple transmit and receive channels with associated antennas or antenna system 107, 203.

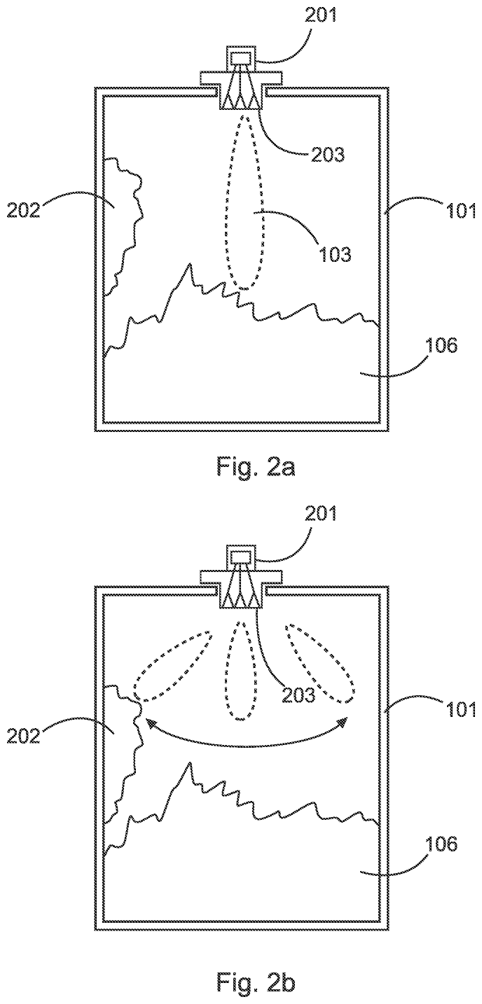

FIG. 2a shows a fill level radar 201 with a fill level antenna 203 and an antenna array 203 which can be used for electronic beam control. With the aid of this measuring device, the product surface can be scanned. Also, buildup 201 on the container wall can be detected.

FIG. 2b shows how the main radiation directions of the antenna array 203 may be changed.

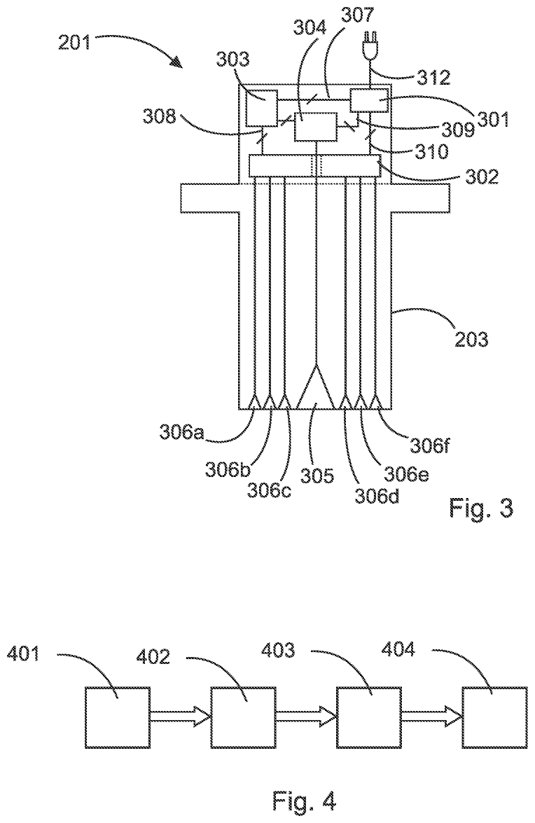

FIG. 3 shows a detailed view of such a fill level radar 201. The fill level radar 201 has a topology radar unit 302, which can detect the topology of, for example, bulk material piles 106 (cf. FIGS. 2a and 2b), as well as a fill level radar unit 305, which can measure the fill levels. These units can be designed separately in terms of circuitry and can be operated independently of each other. In addition, there is a higher-level control unit 303 which can switch on either the topology-detecting radar unit of the fill level-detecting radar unit 304 or both units simultaneously, independently of adjustable parameters.

An advantage of this device is that additional information can be provided in addition to the level value. For example, it can be provided that such a device is used in a bulk material container 101 and detects buildup 202 on the container walls therein. Adhesions are generally not detected by level measuring devices. Adhesions on container walls can lead to, among other things, instability of the container. In addition, buildup on container walls must be taken into account when filling the container. If a certain amount of material is ordered, the quantity ordered is based on the current fill level value. However, if a larger buildup is formed in the container 101, the ordered material will not fit completely into the container and, in the worst case, must be discarded.

The fill level radar unit 304 may be in the form of a radar unit 100. It includes, for example, a monostatic FMCW or pulse radar with an antenna 305 that outputs a distance value to the product.

The topology radar unit 302 represents a radar comprising a type of electronic beam steering (phased array, digital beam forming). Here, a plurality of antenna elements 306a . . . 306f are necessary, as well as a corresponding number of transmitter and/or receiver channels. The output may be seen as, for example, a scanned bulk material surface 106b, a volume, an indicator of buildup 202 in the container, or the like.

The frequency ranges in which the topology radar unit and the fill level radar unit operate are also independent of each other. For example, the units 302, 304 operate in different frequency ranges to reduce interference and corresponding spurious signals when operating simultaneously between channels. For example, the topology radar unit 302 may operate in the range around 80 GHz and the fill level radar unit 304 may operate in the range around 180 GHz.

It is possible that both units 302, 304 are operated according to the FMCW principle. In this case, they may differ in the sweep parameters (bandwidth, ramp slope, . . . ). It is also possible that the modulation modes of the two units are fundamentally different, so that, for example, the fill level radar unit 304 is operated as a pulse radar and the topology radar unit 302 is operated according to the FMCW principle.

The control unit 303 can be implemented by a microcontroller or an FPGA. This unit is adjustable and controls, among other things, the measuring rate. A predefinable measurement cycle can consist, for example, of 15 fill level measurements being carried out in a one second interval, followed by a topology detection measurement.

The duration of the topology measurement can be, for example, several 100 ms.

The temporal grid can be adjusted depending on the available energy. For example, in the process industry, the fill level radar 100, 105, 201 often operates with a two-wire interface 312, with very limited energy available to operate the device. The control unit 303 can adjust this grid according to the adjustable specifications by receiving information about the current available energy via an energy monitoring unit 301.

The energy consumption of the topology sensing radar unit 302 is much higher than the energy consumption of the fill level radar unit 304. For this reason, the above measurement grid is proposed. The excess energy available during the fill level measurement can be temporarily stored in an energy storage unit (which may be located in 301) and reused during the topology sensing radar measurement.

From a process measurement perspective, such a grid is also useful. Fill levels can change rapidly compared to buildup 202. In turn, the buildups 202 are often subject to a slowly changing growth process. Therefore, it makes sense to choose a higher measurement rate for fill level measurement than the measurement rate for topology detection or adhesion detection.

The embodiment example from FIG. 3 shows the internal structure of a fill level radar 201. The control unit 303 is connected to the energy management unit 301 via the connecting lines 307 and is supplied with energy via this. Likewise, information about the currently available energy is exchanged via the connection lines 307. Furthermore, the control unit 303 is connected to the level sensing unit 304 and the topology sensing unit 302. Data is exchanged bidirectionally via the connecting lines 311 and 308. Likewise, control signals are sent from the control unit 303 via the connecting lines 311 and 308, via which the units 304 and 302 can be switched on and off. Furthermore, the measurement results of, for example, unit 304 or other units can be sent to control unit 303. The units 304 and 302 are supplied with energy from the energy management unit 301 via the lines 310 and 309.

The fill level radar unit 304 has a transmit/receive antenna 305 that can transmit and receive a high frequency radar signal.

The topology radar unit 302 has a plurality of independent antenna elements 306a through 306f, which can also be used to transmit and receive high frequency radar signals. All antenna elements 305, 306a to 306f may be combined into an overall antenna system 203.

The energy management unit 301 has an interface 312 via which the device 201 can be supplied with energy. Furthermore, the measured data (fill level, volume, information about buildup, . . . ) can be transmitted to the process control system via this interface. The energy management unit receives this data from the control unit 303, which are abstract units. It is possible that the control tasks of the energy management unit are also taken over by the control unit. This functionality can be taken over by a microprocessor, for example.

In a further embodiment, the measurement intervals can be specified by the user. For example, it can be set in a user preset whether the split is, for example, 80% topology measurement and 20% fill level measurement, 50% topology measurement and 50% fill level measurement, 100% topology measurement and 0% fill level measurement, or also 0% topology measurement and 100% fill level measurement.

Of course, these specifications can only be met if sufficient energy is available for measurement in the energy management unit and its energy storage. The respective cycle times are then based on this. Since a fill level measurement requires less energy than a topology measurement, the measuring rate for a 100% fill level measurement can be higher than for a 100% topology measurement.

Furthermore, times can be defined in which the percentage distribution between topology and fill level measurement is changed. For example, the topology can be measured more frequently at night than during the day.

In another embodiment, the adjustment of the measurement rate is dependent on the fill level. For example, if the fill level changes quickly, the frequency of a topology measurement can be reduced to realize fast tracking of the changing fill level value.

The determination of the surface topology will be able to provide more information when the container is almost empty than when it is almost full. It may therefore be envisaged, in particular, to reduce the time period between two topology measurements when the container is becoming empty.

It is also possible to set the 4 to 20 mA interface in such a way that the characteristic curve is used inversely. Typically, an empty container is signaled to the outside by a current draw of 4 mA and a full container by a current draw of 20 mA. However, it may be intended to draw a current of 20 mA when the container is empty and a current of 4 mA when the container is full. By inverting the characteristic curve in this way, it can be achieved that, while the clamping voltage remains constant, the level measuring device receives increasingly more energy as the container becomes empty, which can then be used to reduce the time intervals between two topology measurements. The inverse operation of the level measuring device can be compensated again without major problems in an evaluation device, for example a PLC, by making the appropriate settings.

In a further embodiment, it is envisaged that the fill level radar for level and topology measurement can draw all its energy required for operation from an energy storage and/or energy harvesting module integrated in the device. In this case, the device is supplemented by a real-time clock, which can be set by the control circuitry. In particular, the next time point for a fill level or topology measurement can be set. After reaching the corresponding point in time, the corresponding unit is activated and the associated measured value is determined. The measured value is transmitted wirelessly to the outside to a cloud, for example. In addition, information can be stored in a non-volatile memory element as to which of the two available radar units is to be used for measurement after the next activation by the real-time clock.

The fill level radar 201 thus has a fill level determining radar unit and a topology detecting radar unit, each of which is operated in parallel or sequentially via a control unit in a predefinable time sequence.

The control unit can determine when the topology radar unit should perform the next measurement, taking into account the available energy (it receives this information from the energy management unit).

FIG. 4 shows a flow diagram of a method according to an embodiment. In step 401, the fill level of the container is detected several times by a fill level radar unit of a fill level radar. In step 402, the available energy is monitored and in step 403 it is decided that, taking into account the available energy, the topology is now to be detected. In step 404, the topology of the product surface is then detected with a topology radar unit of the fill level radar. The fill level radar unit and the topology radar unit have different antennas and each has its own control unit, to which a further control unit may be assigned to control the time sequence.

Supplementally, it should be noted that “comprising” and “comprising” do not exclude other elements or steps, and the indefinite articles “one” or “a” do not exclude a plurality. It should further be noted that features or steps that have been described with reference to any of the above embodiments may also be used in combination with other features or steps of other embodiments described above. Reference signs in the claims are not to be regarded as limitations.

1-13. (canceled)

14. A fill level radar for fill level and topology detection, comprising:
a fill level radar unit configured to detect a fill level of a container;
a topology radar unit configured to detect the topology of a product surface;
an energy management unit configured to monitor available energy; and
control circuitry configured to adjust a timing of measurements of the fill level radar unit and the topology radar unit taking into account available energy.

15. The fill level radar according to claim 14,
wherein the control circuitry is further configured to adjust a time sequence of the measurements of the fill level radar unit and the topology radar unit taking into account the last measured fill level.

16. The fill level radar according to claim 14,
wherein the control circuitry is further configured to adjust the timing of the measurements of the fill level radar unit and the topology radar unit taking into account a last measured rate of change of the fill level.

17. The fill level radar according to claim 14,
wherein the energy management unit comprises an energy storage and is configured to charge the energy storage during a plurality of successive measurements of the fill level radar unit.

18. The fill level radar according to claim 14,
wherein the fill level radar is configured for connection to a 4 mA-20 mA interface.

19. The fill level radar according to claim 18,
wherein the fill level radar is further configured for inverse operation such that when the container is empty the current draw is 20 mA, and when the container is full the current draw is 4 mA.

20. The fill level radar according to claim 14, wherein the control circuitry comprises:
a first control unit configured to control the fill level radar unit,
a second control unit configured to control the topology radar unit, and
a third control unit configured to adjust the timing of the measurements of the fill level radar unit and the topology radar unit, taking into account the available energy.

21. The fill level radar according to claim 14, further comprising:
a first antenna configuration configured to detect the fill level; and
a second antenna configuration configured to detect the topology,
wherein the first antenna configuration is an array antenna having an array of radiator elements arranged around the second antenna configuration.

22. The fill level radar according to claim 21,
wherein the fill level radar is further configured to transmit an FMCW radar signal with the second antenna configuration and an FMCW radar signal or a pulse signal with the first antenna configuration.

23. A method for measuring a fill level of a container and a topology of a product surface, comprising the following steps:
detecting the fill level of the container once or several times with a fill level radar unit of a fill level radar;
monitoring available energy;
deciding whether, taking into account the available energy, the topology is now to be acquired; and
detecting the topology of the product surface with a topology radar unit of the fill level radar.

24. The method according to claim 23, wherein the deciding whether the topology is to be acquired is made taking into account the last measured fill level or a last measured rate of change of the fill level.

25. A nontransitory computer-readable storage medium comprising computer program instructions stored therein, which when executed on a processor of a level meter, instructs the level meter to perform the following steps:
detecting the fill level of the container once or several times with a fill level radar unit of a fill level radar;
monitoring available energy;
deciding whether, taking into account the available energy, the topology is now to be acquired; and
detecting the topology of the product surface with a topology radar unit of the fill level radar.
